(19) United States
(12) Patent Application Publication
(10) Pub. No.: US 2026/0206746 A1
(43) Pub. Date: Jul. 23, 2026

(54) ENCAPSULATED AGRICULTURAL CHEMICALS

(71) Applicant: Dow Global Technologies LLC, Midland, MI (US)

(72) Inventors: Luqing Qi, Midland, MI (US); Binghe Gu, Midland, MI (US); Xue Chen, Manvel, TX (US); Stephanie A. Bloxom, Midland, MI (US)

(21) Appl. No.: 19/142,305

(22) PCT Filed: Mar. 11, 2024
(86) PCT No.: PCT/US2024/019348

§ 371 Date: Jun. 23, 2025

Related U.S. Application Data
(60) Provisional application No. 63/454,144, filed on Mar. 23, 2023.

(51) Int. Cl. A01N 25/28; A01N 25/10; A01N 37/22; A01P 13/00

(52) U.S. Cl. CPC A01N 25/28; A01N 25/10; A01N 37/22; A01P 13/00

(57) ABSTRACT

An agricultural chemical, such as a fertilizer, insecticide, herbicide or fungicide, can be encapsulated with a polyurea coating made by reacting a polyisocyanate and with a polyamine. Bis-(piperazinylalkyl)amines, such as bis-(2-(piperazin-1-yl)ethyl)amine, can modify the rate of release of the agricultural chemical from the encapsulating shell.

### FIELD

This application relates to the field of agricultural chemicals.

### INTRODUCTION

Many different chemical products are applied to lawns, gardens, fields, orchards and trees, plant beds, ornamental plants and other outdoor plants, potted plants and hydroponic beds. These chemicals include fertilizers, herbicides, pesticides and fungicides, which may collectively be called “agricultural chemicals” and are also frequently called “actives”.

It is known to slow and extend the activity of agricultural chemicals by encapsulating the agricultural chemical in a coating that slowly releases it. See, for example, U.S. Pat. No. 10,813,352B2. Different coatings can provide different release rates. It is desirable to create new coatings that are suitable for use in encapsulated agricultural chemicals and that can provide unique release rates.

### SUMMARY

One aspect of the present invention is an encapsulated agricultural chemical composition comprising particles that contain:
1. A liquid core that contains an agricultural chemical; and
2. A solid shell encapsulating the liquid core that contains a polyurea polymer which contains repeating segments derived from a polyamine monomer that complies with Formula 1:

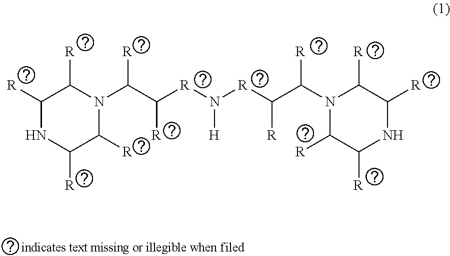

wherein each R¹ is independently hydrogen, an alkyl group or a substituted alkyl group and each R² is independently a bond, a divalent alkyl group, or a substituted divalent alkyl group. For the purposes of this application, polyamine monomers that comply with Formula 1 are called “bis-(piperazinylalkyl)amine monomers” or “BPAA”.

A second aspect of the present invention is a process to make an encapsulated agricultural chemical composition, comprising the steps of:
1. Making an emulsion, which contains a dispersed organic phase comprising agricultural chemical and polyisocyanate monomers, dispersed in a continuous aqueous phase; and
2. Contacting the emulsion with polyamine monomers that include BPAA monomers, under conditions such that the polyisocyanate monomers and the polyamine monomers react to make a shell that contains polyurea polymer and encapsulates the agricultural chemical.

The end product contains particles having a solid shell that encapsulates a liquid core. The liquid core contains agricultural chemicals. The solid shell contains polyurea polymer. The encapsulated agricultural chemical compositions of this invention have a different release rate than some agricultural chemicals that are encapsulated using a different polyamine monomer.

### DETAILED DESCRIPTION

This invention relates to an encapsulated agricultural chemical composition that contains particles having a core-shell structure. The core is liquid and contains an agricultural chemical. The shell is solid and contains a polyurea polymer. The polyurea polymer contains repeating segments derived from the BPAA polyamine illustrated in Formula 1.

The liquid core of the particles contains an agricultural chemical as previously described.

### Examples of Suitable Agricultural Chemicals Include:

Fertilizers: Many fertilizers contain one or more nitrogen, phosphorus and/or potassium compounds such as ammonium nitrate, urea and urea compounds (for example methylene diurea and isobutylidene diurea and crotonylidene diurea), sodium nitrate, phosphate salts such as diammonium phosphate, and potassium salts such as potassium chloride, potassium sulfate, potassium carbonate or potassium nitrate or mixtures such as potash. In some embodiments, the fertilizer may also contain iron or other minerals.
Insecticides: Examples of common insecticides include organochlorine compounds, organophosphate compounds, organosulfur compounds, carbamates, formamides, pyrethroids, nicotinoids, spinosyns, pyrazoles, quinazolines and benzoyl ureas.
Herbicides: Examples of common herbicides include metolachlor and other chloroacetanilide herbicides, glyphosate, imazethapyr, thifensulfuron, atrazine, cyanazine, chlorophenoxy compounds such as 2,4-dicholorophenoxyacetic acid, 2-methyl-4-chlorophenoxyacetic acid, dicamba and their salts, trifluralin and pendimethalin.
Fungicides: Examples of common fungicides include captan, folpet, dithiocarbamates, pentachlorophenol, flutolanil, boscalid, penthiopyrad, fluxapyroxad, fluopyram, and pydiflumetofen.
Nematicides: Examples of common nematicides include ethoprophos, terbufos and fluazaindolizine.
   Suitable agricultural chemicals are known and commercially available. They are described in publications such as: “List of Common Agricultural Fertilizers”, available at: https://www.gardenguides.com/12405093-list-of-common-agricultural-fertilizers.html, “Insecticides”, made available by the US EPA at https://www.epa.gov/caddis-vol2/insecticides, “Herbicides”, made available by the US EPA at https://www.epa.gov/caddis-vol2/herbicides, “Fungicides, Bactericides and Nematicides”, available at https://pnwhandbooks.org/sites/pnwhandbooks/files/plant/pesticide-articles/contentpdf/pdfs/fungicides-bactercides-table.pdf.

In some embodiments, the liquid core further comprises an organic solvent. The organic solvent is liquid at ambient temperatures (25° C.). In some embodiments, the organic solvent is a hydrocarbon. The organic solvent is aliphatic in some embodiments, is aromatic in some embodiments and is aliphatic-aromatic in some embodiments. In some embodiments, the organic solvent contains on average at least 4 carbon atoms or at least 6 carbon atoms or at least 8 carbon atoms or at least 9 carbon atoms. In some embodiments, the organic solvent contains on average at most 16 carbon atoms or at most 14 carbon atoms or at most 12 carbon atoms or at most 11 carbon atoms. Typically, the organic solvent minimizes groups that react with an isocyanate or amine group, such as minimizing acid, alcohol, thiol and primary or secondary amine groups. In some embodiments, tertiary amine and ether linkages may be acceptable. Suitable organic solvents are known and commercially available.

In some embodiments, the agricultural chemical is liquid at ambient temperature. In some embodiments, the agricultural chemical is solid at ambient temperature and is dissolved in an organic solvent.

In some embodiments, the liquid core contains at least 30 weight percent agricultural chemical or at least 50 weight percent or at least 70 weight percent or at least 80 weight percent or at least 90 weight percent. In some embodiments, the liquid core contains 100 weight percent agricultural chemical or at most 98 weight percent agricultural chemical or at most 95 weight percent or at most 92 weight percent. In some embodiments, the liquid core contains 0 weight percent solvent or at least 2 weight percent or at least 5 weight percent or at least 8 weight percent. In some embodiments, the liquid core contains at most 70 weight percent organic solvent or at most 50 weight percent or at most 30 weight percent or at most 20 weight percent or at most 10 weight percent.

The solid shell of the encapsulated agricultural chemical composition contains a polyurea polymer. Polyurea polymers can be made by condensation polymerization of polyisocyanate monomers and polyamine monomers.

In some embodiments, the polyisocyanate monomers contain on average at least 1.5 isocyanate groups per molecule or at least 1.9 isocyanate groups per molecule or at least 2 isocyanate groups per molecule. In some embodiments, the polyisocyanate monomers contain on average no more than 6 isocyanate groups per molecule or no more than 4 isocyanate groups per molecule or no more than 3 isocyanate groups per molecule or no more than 2.5 isocyanate groups per molecule or no more than 2 isocyanate groups per molecule.

The isocyanate groups in a polyisocyanate monomer are linked by an organic moiety (R³). The organic moiety may be aliphatic, aromatic or aliphatic-aromatic. In some embodiments, the organic moiety contains at least 4 carbon atoms or at least 6 carbon atoms. In some embodiments, the organic moiety contains at most 20 carbon atoms or at most 18 carbon atoms or at most 16 carbon atoms. In some embodiments, the organic moiety is a hydrocarbon. In some embodiments, aliphatic groups of the organic moiety are alkyl groups.

Polyisocyanate monomer generally meets Formula 2

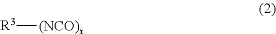

wherein R³ is an organic moiety as previously described and x is a number of isocyanate groups as previously described.

Examples of polyisocyanate monomers include methylenediphenyl diisocyanate (MDI), toluene diisocyanate (TDI), isophorone diisocyanate (IPDI), hexamethylene diisocyanate (HDI), methylene bis (4-cyclohexylisocyanate) (HMDI), naphthalene diisocyanate (NDI), xylylene diisocyanate, phenylene diisocyanate, substituted biphenyl diisocyanates, dicyclohexylmethane diisocyanate, and hexamethylene diisocyanate. In some embodiments, the polyisocyanate monomers are selected from 4,4′ diphenylmethane diisocyanate (MDI), 2,4- or 2,6-toluene diisocyanate (TDI) and/or isophorone diisocyanate (IPDI). In some embodiments, the polyisocyanate monomer is 4,4′ diphenylmethane diisocyanate (MDI). In some embodiments, the polyisocyanate monomer is 2,4-2,6-toluene diisocyanate (TDI). In some embodiments, the polyisocyanate monomer is isophorone diisocyanate (IPDI).

In some embodiments, the polyisocyanate monomers contain a single variety of polyisocyanate monomer. In some embodiments, the polyisocyanate monomers contain a mixture of two or more varieties of polyisocyanate monomers.

Many polyisocyanate monomers are commercially available, such as under the PAPI™ and VORONATE™ trademarks. Others can be made by known processes, such as by phosgenation of diamines or by reacting a dicarboxylic acid with ammonia and hydrazoic acid.

The polyamine monomers comprise a plurality of active amine groups. Active amine groups are primary or secondary amine groups that can react with a polyisocyanate monomer to form a urea linkage. In some embodiments, the polyamine monomers comprise on average at least 1.5 active amine groups per molecule or at least 1.7 active amine groups per molecule or at least 1.9 active amine groups per molecule or at least 2 active amine groups per molecule or at least 2.2 active amine groups per molecule or at least 2.5 active amine groups per molecule or at least 2.7 active amine groups per molecule or at least 3 active amine groups per molecule. In some embodiments, the polyamine monomers comprise on average at most 8 active amine groups per molecule or at most 6 active amine groups or at most 4 active amine groups or at most 3.5 active amine groups or at most 3 active amine groups.

In some embodiments, either the polyisocyanate monomers or the polyamine monomers or both contain on average more than 2 reactive groups (isocyanate groups or active amine groups) per molecule, so that the resulting polyurea polymer contains cross-linking. In some embodiments, either the polyisocyanate monomers or the polyamine monomers or both contain on average at least 2.2 reactive groups per molecule or at least 2.5 reactive groups or at least 2.7 reactive groups or at least 3 reactive groups.

The amine groups in a polyamine monomer are linked by one or more organic moieties (such as R⁴ and R⁵). Each organic moiety may be aliphatic, aromatic or aliphatic-aromatic. In some embodiments, each organic moiety contains on average at least 2 carbon atoms or at least 4 carbon atoms or at least 6 carbon atoms. In some embodiments, the organic moiety contains on average at most 30 carbon atoms or at most 24 carbon atoms or at most 20 carbon atoms. In some embodiments, the polyamine monomer contains on average at least 2 carbon atoms or at least 4 carbon atoms or at least 6 carbon atoms. In some embodiments, the polyamine monomer contains on average at most 30 carbon atoms or at most 24 carbon atoms or at most 20 carbon atoms. In some embodiments, the organic moieties in the polyamine monomer are a hydrocarbon moieties. In some embodiments, any aliphatic groups of the organic moieties are alkyl groups.

Some embodiments of polyamine monomers meet Formula 3

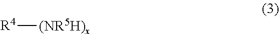

wherein R⁴ is an organic moiety as previously described, R⁵ is hydrogen or an organic moiety and x is a number of amine groups as previously described. In some embodiments, R⁴ and R⁵ are connected to form a cyclic organic moiety.

The polyamine monomers comprise BPAA monomers, which meet Formula 1 (repeated from above):

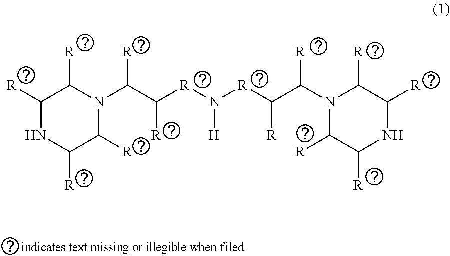

wherein each R¹ is independently hydrogen, an alkyl group or a substituted alkyl group, and each R² is independently a bond, a divalent alkyl group, or a substituted divalent alkyl group. The BPAA monomers contain three secondary amine groups: a central amine group linked to the two R² moieties and two secondary amine groups that are part of the two cyclic piperazinyl moieties. We hypothesize, without limitation, that all three secondary amine groups in the BPAA monomer are active amine groups, but the central amine group may have a different reactivity from the secondary amine groups in the piperazinyl moieties.

In some embodiments, each R¹ group in the BPAA is independently hydrogen or an alkyl moiety containing from 1 to 8 carbon atoms or from 1 to 6 carbon atoms or from 1 to 4 carbon atoms or from 1 to 2 carbon atoms. In some embodiments, each R¹ group in the BPAA is independently hydrogen or a methyl group. In some embodiments, each R¹ group in the BPAA is hydrogen.

In some embodiments, each R² group in the BPAA independently contains from 0 to 10 carbon atoms or from 0 to 8 carbon atoms or from 0 to 6 carbon atoms or from 0 to 4 carbon atoms or from 0 to 2 carbon atoms. In some embodiments, each R² group is a bond. In some embodiments, each R² group is a methylene group. In some embodiments, each R² group is an ethylene group. In some embodiments, when R² groups contain 2 or more carbon atoms, the bonds to the central amine group and to the alkylpiperazine group are attached to adjacent carbon atoms (α-position with respect to each other).

In some embodiments, the BPAA is selected from the group consisting of bis-(2-(piperazin-1-yl)ethyl)amine [BPEA, which may also be called bis-(2-(n-piperazinyl)ethyl)amine], bis-(3-(piperazin-1-yl)propyl)amine [bis-(3-(n-piperazinyl)propyl)amine], bis-(4-(piperazin-1-yl)butyl)amine [bis-(4-(n-piperazinyl)butyl)amine], bis-(5-(piperazin-1-yl)pentyl)amine [bis-(5-(n-piperazinyl)pentyl)amine], bis-(6-(piperazin-1-yl)hexyl)amine [bis-(6-(n-piperazinyl)hexyl)amine], bis-(1-(piperazin-1-yl)propan-2-yl)amine, and bis-(2-(piperazin-1-yl)propyl)amine [bis-(2-(n-piperazinyl)propyl)amine]. In some embodiments, the BPAA is BPEA.

The BPAA monomer can be made using the process described in PCT Publication WO 2013/101345 A1.

In some embodiments, essentially all polyamine monomers are BPAA monomers. In some embodiments, the polyamine monomers comprise a mixture of polyamine monomers that contains BPAA and at least one other polyamine monomer. Polyamine monomers that are useful to make polyurea polymers are known and commercially available. Examples include alkyl diamines, alkyl triamines, alkyl tetramines, phenylene diamine and substituted versions thereof.

In some embodiments, the BPAA monomer makes up at least 25 weight percent of the polyamine monomers or at least 50 weight percent or at least 70 weight percent or at least 80 weight percent or at least 90 weight percent. In some embodiments, the BPAA monomer makes up essentially 100 weight percent of the polyamine monomers.

In the process of this invention, the agricultural chemical and the polyisocyanate monomers are emulsified in an aqueous solvent. In many embodiments, organic solvent and/or emulsifiers are used to aid in forming the emulsion. The resulting emulsion is an “oil-in-water” emulsion, comprising a dispersed organic phase in a continuous aqueous phase. The dispersed organic phase contains the organic components of the emulsion, including the agricultural chemical, the polyisocyanate monomers and any organic solvent or other organic components. In many embodiments, it is the form of organic microspheres, such as having a mean sphere diameter from 1 micron to 100 micron. The continuous aqueous phase is commonly called an aqueous “solvent”. The term “solvent” does not imply that the organic phase or the resulting encapsulated particles are dissolved in the aqueous solvent; rather they are dispersed and suspended in the solvent to form an emulsion.

The quantity of water should be sufficient so that the emulsion contains a continuous aqueous phase and a dispersed organic phase. In some embodiments, the weight ratio of agricultural chemical to water in the emulsion is at least 50 percent or at least 60 percent or at least 70 percent or at least 80 percent or at least 85 percent or at least 90 percent. In some embodiments, the weight ratio of agricultural chemical to water in the emulsion is at most 150 percent or at most 120 percent or at most 110 percent or at most 100 percent or at most 105 percent or at most 100 percent.

The quantity of isocyanate monomer should be sufficient to provide the desired amount of solid shell around the liquid core. In some embodiments, the weight ratio of polyisocyanate monomers to agricultural chemical in the emulsion is at least 1 percent or at least 2 percent or at least 4 percent or at least 6 percent or at least 8 percent. In some embodiments, the weight ratio of polyisocyanate monomers to agricultural chemical in the emulsion is at most 25 percent or at most 20 percent or at most 18 percent or at most 16 percent or at most 14 percent or at most 12 percent or at most 10 percent.

In some embodiments, emulsifiers are used to aid in forming the emulsion. Many emulsifiers are known and commercially available. Examples of suitable emulsifiers include surfactants and polyvinyl alcohols. Suitable emulsifiers are sold under the TERGITOL™ and DOW™ PVOH trademarks. Other suitable emulsifiers are described as dispersants in U.S. Pat. No. 10,813,352 B2 at col 31, line 55 to col 32, line 9. When emulsifiers are used, they are used in a quantity sufficient to form an emulsion. In some embodiments, the weight ratio of emulsifier to agricultural chemical is at least 0.1 percent or at least 0.5 percent or at least 1 percent or at least 2 percent or at least 3 percent. In some embodiments, the weight ratio of emulsifier to agricultural chemical is at most 20 percent or at most 15 percent or at most 10 percent or at most 8 percent or at most 6 percent or at most 4 percent.

The emulsion is subjected to conditions that are suitable to promote the reaction of the polyisocyanate monomers with the polyamine monomers to form urea linkages. In some embodiments, the temperature of the emulsion is at least 0° C. or at least 10° C. or at least 20° C. In some embodiments, the temperature of the emulsion is at most 100° C. or at most 70° C. or at most 50° C. or at most 40° C. or at most 30° C. The emulsion may be maintained under air or under neutral atmosphere such as nitrogen or carbon dioxide or helium.

The emulsion is contacted with the polyamine monomers. For example, the polyamine monomers may be dissolved in water and added to the emulsion with agitation.

The quantity of polyamine monomers should be sufficient to form a solid shell encapsulating the agricultural chemical. In some embodiments, the molar ratio of active amine groups in the polyamine monomers to isocyanate groups in the polyisocyanate monomers is at least 30 percent or at least 40 percent or at least 50 percent or at least 60 precent or at least 70 percent or at least 80 percent or at least 90 precent or at least 100 percent. In some embodiments, the molar ratio of active amine groups in the polyamine monomers to isocyanate groups in the polyisocyanate monomers is at most 400 percent or at most 300 percent or at most 250 percent or at most 200 percent or at most 150 percent.

The weight ratio of polyamine monomers to polyisocyanate monomers may vary depending on the molecular weights of the monomers. In some embodiments, the weight ratio of polyamine monomer to polyisocyanate monomer is at least 10 percent or at least 20 percent or at least 30 percent or at least 40 percent or at least 50 percent. In some embodiments, the weight ratio of polyamine monomer to polyisocyanate monomer is at most 250 percent or at most 200 percent or at most 180 percent or at most 160 percent or at most 150 percent.

The reaction mixture may optionally contain adjuvants and other additives. For example, some herbicides contain surfactants, crop oil concentrates and/or ammonium fertilizers to assist their performance. Some pesticides may contain stabilizers and/or solubilizers. In some embodiments, pore-formers may be added to increase the porosity of the shell.

The polyisocyanate monomers and polyamine monomers are permitted to react until a polyurea shell is formed encapsulating the liquid organic core. The optimum reaction time may vary depending on the monomer used. In some embodiments, the reaction time is at least 1 second or at least 20 seconds or at least 1 minute. In some embodiments, the reaction time is at most 24 hours or at most 12 hours or at most 6 hours or at most 1 hour or at most 30 minutes or at most 15 minutes.

The reaction of isocyanate groups and amine groups to form urea linkages is known and described in references such as Santana et al., Polyureas Versatile Polymers for New Academic and Technological Applications, 13 Polymers 4393 (2021), available at https://doi.org/10.3390/polym13244393. Many embodiments can be illustrated by Formula 3:

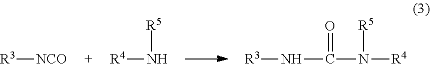

wherein R³, R⁴ and R⁵ have the meaning and embodiments previously described.

The reaction forms an emulsion having particles that contain a liquid organic core with agricultural chemical encapsulated in a solid polyurea shell. The particles are dispersed in an aqueous solution. The emulsion is one embodiment of the encapsulated agricultural chemical composition, and the particles are another embodiment.

The chemical make-up of the liquid core reflects the organic components in the emulsion—the agricultural chemical plus organic solvent and other organic adjuvants or additives. The chemical makeup of the solid shell includes a polyurea polymer that derives from and reflects the chemical make-up of the polyisocyanate monomers and the polyamine monomers.

The emulsion may also contain other components such a surfactants, adjuvants or additives, as previously discussed. The other components may be located in the core and/or in the shell and/or in the aqueous solvent.

In some embodiments, the particles have a mean particle diameter of at least 1 micron or at least 2 micron or at least 3 micron or at least 5 micron. In some embodiments, the particles have a mean particle diameter of at most 100 micron or at most 50 micron or at most 30 micron or at most 25 micron or at most 20 micron or at most 15 micron.

The optimum ratio of polyurea to agricultural chemical in the particles may vary depending on the desired release of agricultural chemical and on the monomers selected to make the polyurea. In some embodiments, the average weight ratio of polyurea to agricultural chemical in the particles is at least 1 percent or at least 2 percent or at least 4 percent or at least 6 percent or at least 8 percent or at least 10 percent or at least 12 percent. In some embodiments, the average weight ratio of polyurea to agricultural chemical in the particles is most 50 percent or at most 40 percent or at most 30 percent or at most 28 percent or at most 26 percent or at most 24 percent or at most 22 percent or at most 20 percent or at most 18 percent or at most 16 percent or at most 14 percent.

In some embodiments, the emulsion contains at least 20 weight percent agricultural chemical or at least 30 weight percent or at least 35 weight percent or at least 40 weight percent or at least 45 weight percent, based on the total weight of the emulsion including aqueous solvent. In some embodiments, the emulsion contains at most 70 weight percent agricultural chemical or at most 65 weight percent or at most 60 weight percent or at most 55 weight percent or at most 50 weight percent, based on the total weight of the emulsion including aqueous solvent. In some embodiments, the emulsion contains at least 35 weight percent water or at least 40 weight percent or at least 45 weight percent or at least 50 weight percent, based on the total weight of the emulsion including aqueous solvent. In some embodiments, the emulsion contains at most 75 weight percent water or at most 65 weight percent or at most 60 weight percent or at most 55 weight percent or at most 50 weight percent, based on the total weight of the emulsion including aqueous solvent. The remainder of the elusion comprises the other components, such as the polyurea polymer, organic solvent, surfactants and other additives and adjuvants. The encapsulated agricultural chemicals are intended to be applied to lawns, gardens, fields, orchards and trees, plant beds, ornamental plants and other outdoor plants, potted plants and/or hydroponic beds. The aqueous dispersion may be applied by known means, such as spraying.

In some embodiments, the emulsion may be applied as it is. In some embodiments, part or all of the water may be removed from the emulsion.

In many embodiments, the emulsion will be diluted with further water before use. The desired level of dilution may vary depending on the agricultural chemical and its concentration in the original emulsion. In some embodiments, the diluted emulsion contains at least 0.01 weight percent agricultural chemical or at least 0.1 weight percent. In some embodiments, the diluted emulsion contains at most 5 weight percent agricultural chemical or at most 1 weight percent.

The optimum rate of release for the agricultural chemical from the encapsulated agricultural chemical composition varies depending on the agricultural chemical and its intended use. In some embodiments, when tested according to the Test Methods for 1 day, the encapsulated agricultural chemical composition release less than 50 percent of the agricultural chemical or no more than 30 percent or no more than 20 percent or no more than 15 percent or no more than 10 percent or no more than 8 percent or no more than 6 percent or no more than 5 percent or no more than 4 percent or no more than 2 percent. In some embodiments, when tested according to the Test Methods for 1 day, the encapsulated agricultural chemical composition release at least 0.1 percent or at least 0.5 percent or at least 1 percent of the agricultural chemical. In some embodiments, the same limits for release of agricultural chemical can be met after 5 days.

In some embodiments, when tested according to the Test Methods for 15 days, the encapsulated agricultural chemical composition release less than 70 percent of the agricultural chemical or less than 60 percent or less than 50 percent or less than 40 percent or less than 30 percent or less than 20 percent or less than 10 percent or less than 5 percent. In some embodiments, when tested according to the Test Methods for 15 days, the encapsulated agricultural chemical composition release at least 1 percent of the agricultural chemical or at least 2 percent or at least 5 percent or at least 10 percent or at least 15 percent or at least 20 percent or at least 25 percent or at least 30 percent.

### Test Methods

The following tests are used to perform measurements in this application:

| | |
|---|---|
| Capsule Particle | measured by Beckman Coulter |
| Size | Particle Size Analyzer |
| | (Universal Liquid Module). |
| Active Release | See description below |
| Rate | |

### Active Release Rate:

An emulsion of the encapsulated agricultural chemical composition, containing about 40 weight percent of the agricultural chemical is gently mixed with a spatula to make a homogeneous slurry. Around 80 mg of the emulsion is added to 100 mL of water in a glass vial, and the solution was placed in a hood. At intervals of 2 hrs., 1 day, 2 day, 5 day, 7 day and 15 days, the solution is vigorously shaken by hand, and a few mL of the solution is filtered through a 0.45 μm nylon syringe filter.

The quantity of s-metolachlor remaining in the filtrate is measured using an Agilent 1290 Infinity liquid chromatography system with a binary pump and Max-Light flow cell with 10 mm optical pathlength. Mass spectrometry is used for peak identification, and ultraviolet spectrometry is used for quantitation. An Openlab Chemstation chromatography data system is used to analyze results. External standard calculation is used for the measurement where the calibration standard is prepared by weighing ~10 mg s-metolachlor in 20 mL of 50/50 v/v acetonitrile/water.

### Details are Set Out Below:

| Column | Agilent Eclipse Plus C18, 1.8 μm, 3.0 × 50 mm | | | | |
|---|---|---|---|---|---|
| Mobil Phase A | Water/0.1% formic acid | | | | |
| Mobil Phase B | Acetonitrile/0.1% formic acid | | | | |
| Column flow rate | 1 mL/min | | | | |
| Injection Volume | 2 μL | | | | |
| Column temp. | 35° C. | | | | |
| UV-Vis detection | 270 (4 nm) detection with 360 | | | | |
| | (5 nm) reference wavelength | | | | |
| MS Settings | 0.3 min solvent delay | | | | |
| | 50-1000 amu scanning | | | | |
| | Operated under both positive | | | | |
| | and negative modes | | | | |
| Mobile phase gradient | t/min | 0 | 3 | 3.1 | 4 |
| programming | % B | 35 | 70 | 35 | 35 |

### EXAMPLES

The following Examples illustrate the invention. The ingredients in Table 1 are used in these Examples:

TABLE 1
Ingredients

| Ingredient Type | Ingredient Name |
|---|---|
| Active Ingredient | s-metolachlor (Sigma Chemical) |
| Solvent | ExxonMobil Aromatic 150 C₉-C₁₁ |
| | aromatic hydrocarbon blend |
| Isocyanate PAPI 27 | DOW ™ PAPI 27 polymethylene |
| | polyphenylisocyanate |
| Isocyanate IPDI | Isophorone diisocyanate (Sigma Chemical) |
| Emulsifier | Polyvinyl alcohol (PVOH) Mw 9000-10000, |
| | 80% hydrolyzed (Sigma Chemical) |
| Emulsifier | TERGITOL ™ 15-s-7 secondary alcohol ethoxylate |
| Amine crosslinker | BPEA Cyclic amine, chemical structure in FIG. 2 |
| Amine crosslinker | DOW ™ Ethylenediamine (EDA) |
| Amine crosslinker | DOW ™ Diethylenetriamine (DETA) |
| Amine crosslinker | DOW ™ Triethylene-tetramine (TETA) |
| Amine crosslinker | DOW ™ Tetraethylenepentamine (TEPA) |

A mixture of 18 g of s-metolachlor active ingredient and 1.2 g Aromatic 150 solvent and an amount of polyisocyanate (PAPI 27 or IPDI) shown in Table 2 are added into a 100 ml beaker. A 19.2 g quantity of 2.5 wt % PVOH aqueous solution is premixed with 0.13 g TERGITOL™ 15-s-7 surfactant and injected into the beaker.

The mixture is emulsified using either a Sliverson L5MA model homogenizer at 8000 rpm for 30 seconds or a pitched three blade-propeller driven by overhead mixer at 2000 rpm for 60 seconds. After the emulsification step, the emulsion is set under an overhead mixer at 500 rpm. A 30 wt % amine cross-linker aqueous solution is dripped into the beaker at ~20-30 drops/min until the amount in Table 2 is added (about 60-90 seconds). After the amine crosslinker solution is added, the encapsulation suspension is stirred using a stir bar at ~100 rpm for 12 hours to drive shell formation at the interface. The finished encapsulated samples are stored for testing. The particle size of particles in each sample are summarized in Table 2.

Sixteen samples listed in Table 2 are generated. IE1 to IE12 are examples of the invention, and CE13-CE16 are Comparative Examples. The particle sizes of each sample are measured as described in the Test Methods. After dilution with water, the release profile of each sample is measured at intervals for 15 days as described in the Test Methods. The results of these tests are recorded on Table 2.

TABLE 2
Encapsulated Products and Characteristics

| | | | | | Shell | | | | | | | |
|---|---|---|---|---|---|---|---|---|---|---|---|---|
| | | | | Particle | to Ag | | | | | | | |
| | PAPI | | 30% | size | Chem | | % Active release | | | | | |
| Sample | 27 | IPDI | amine | D mean | ratio | Amine:isocyanate | 1 | 1 | 2 | 5 | 7 | 15 |
| # | (g) | (g) | (g) | (micron) | (wt %) | mole ratio | hours | day | days | days | days | days |
| IE1 | 1.6 | 0 | 2.49 | 13.22 | 13 | 0.77:1 | 1.4 | 5.2 | 9.0 | 19.6 | 26.0 | 43.9 |
| | | | BPEA | | | | | | | | | |
| IE2 | 1.6 | 0 | 1.62 | 13.00 | 12 | 0.5:1 | 1.4 | 7.1 | 12.2 | 23.4 | 30.1 | 49.8 |
| | | | BPEA | | | | | | | | | |
| IE3 | 1.6 | 0 | 4.86 | 12.44 | 17 | 1.5:1 | 1.0 | 3.9 | 6.9 | 15.8 | 21.5 | 43.1 |
| | | | BPEA | | | | | | | | | |
| IE4 | 1.6 | 0 | 6.48 | 11.53 | 20 | 2:1 | 0.9 | 4.3 | 8.4 | 17.1 | 23.3 | 43.9 |
| | | | BPEA | | | | | | | | | |
| IE5 | 0.8 | 0 | 1.25 | 12.68 | 7 | 0.77:1 | 2.5 | 10.8 | 18.2 | 33.2 | 40.9 | 63.3 |
| | | | BPEA | | | | | | | | | |
| IE6 | 0.53 | 0 | 0.83 | 10.33 | 4 | 0.77:1 | 5.1 | 21.9 | 33.7 | 52.2 | 58.9 | 70.8 |
| | | | BPEA | | | | | | | | | |
| IE7 | 0 | 1.6 | 3.04 | 12.06 | 14 | 0.77:1 | 0.2 | 0.5 | 0.6 | 0.7 | 0.9 | 1.2 |
| | | | BPEA | | | | | | | | | |
| IE8 | 0 | 1.6 | 1.93 | 14.14 | 12 | 0.5:1 | 0.3 | 1.0 | 1.1 | 1.2 | 1.5 | 1.6 |
| | | | BPEA | | | | | | | | | |
| IE9 | 0 | 1.6 | 5.84 | 12.18 | 19 | 1.5:1 | 0.2 | 0.4 | 0.3 | 0.6 | 0.8 | 1.2 |
| | | | BPEA | | | | | | | | | |
| IE10 | 0 | 1.6 | 7.71 | 14.00 | 22 | 2:1 | 0.3 | 0.4 | 0.5 | 0.8 | 0.6 | 1.1 |
| | | | BPEA | | | | | | | | | |
| IE11 | 0 | 0.8 | 1.52 | 12.96 | 7 | 0.77:1 | 0.6 | 1.1 | 1.6 | 2.3 | 2.6 | 4.2 |
| | | | BPEA | | | | | | | | | |
| IE12 | 0 | 0.53 | 1.01 | 14.62 | 5 | 0.77:1 | 0.5 | 2.0 | 3.1 | 3.9 | 4.8 | 8.1 |
| | | | BPEA | | | | | | | | | |
| CE13 | 1.6 | 0 | 0.93 | 15.04 | 10 | 0.77:1 | 42.2 | 71.3 | 72.4 | 73.8 | | |
| | | | EDA | | | | | | | | | |
| CE14 | 1.6 | 0 | 1.06 | 14.46 | 11 | 0.77:1 | 3.7 | 23.0 | ~30.0 | 50.2 | | 67.1 |
| | | | DETA | | | | | | | | | |
| CE15 | 1.6 | 0 | 1.13 | 14.33 | 11 | 0.77:1 | 5.0 | 24.2 | 35.6 | 52.5 | | |
| | | | TETA | | | | | | | | | |
| CE16 | 1.6 | 0 | 1.17 | 14.75 | 11 | 0.77:1 | 7.1 | 26.0 | 37.1 | 48.9 | | |
| | | | TEPA | | | | | | | | | |

1. An encapsulated agricultural chemical composition comprising particles that contain:
(a) A liquid core that contains an agricultural chemical; and
(b) A solid shell encapsulating the liquid core that contains a polyurea polymer which contains repeating units derived from a polyamine monomer that complies with Formula 1, called a “BPAA monomer”: 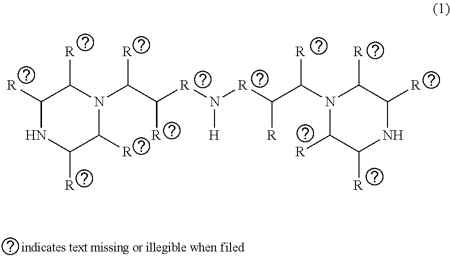
wherein each R¹ is independently hydrogen, an alkyl group or a substituted alkyl group and each R² is independently a bond, a divalent alkyl group, or a substituted divalent alkyl group.

2. The encapsulated agricultural chemical composition of claim 1 wherein the polyurea polymer is a reaction product of at least one variety of polyisocyanate monomers and at least one variety of polyamine monomers, wherein the polyamine monomer comprises BPAA monomers.

3. The encapsulated agricultural chemical composition of claim 1 wherein the particles are dispersed in an aqueous solvent forming an emulsion.

4. The encapsulated agricultural chemical composition of claim 3 wherein the emulsion contains from 30 to 60 weight percent agricultural chemical, based on the total weight of the emulsion including aqueous solvent.

5. The encapsulated agricultural chemical composition of claim 3 wherein each R¹ and R² in the BPAA monomer is independently a hydrogen atom or an alkyl group containing from 1 to 4 carbon atoms and each R³ in the BPAA monomer contains from 0 to 8 carbon atoms.

6. The encapsulated agricultural chemical composition of claim 3 wherein the BPAA monomer is selected from the group consisting of: bis-(2-(piperazin-1-yl)ethyl)amine, bis-(3-(piperazin-1-yl)propyl)amine, bis-(4-(piperazin-1-yl)butyl)amine, bis-(5-(piperazin-1-yl)pentyl)amine, bis-(6-(piperazin-1-yl)hexyl)amine, bis-(1-(piperazin-1-yl)propan-2-yl)amine, and bis-(2-(piperazin-1-yl)propyl)amine.

7. The encapsulated agricultural chemical composition of claim 3 wherein the BPAA monomer is bis-(2-(piperazin-1-yl)ethyl)amine.

8. The encapsulated agricultural chemical composition of claim 6 wherein the BPAA monomers make up from 50 to 100 weight percent of the polyamine monomers.

9. The encapsulated granular composition of claim 6 wherein the BPAA monomers make up from 90 to 100 weight percent of the polyamines used to make the polyurea polymer.

10. The encapsulated agricultural chemical composition of claim 1 wherein the weight ratio of polyurea polymer to agricultural chemical in the particles is from 2 to 30 percent.

11. The encapsulated agricultural chemical composition of claim 10 wherein the agricultural chemical comprises at least one of an insecticide, an herbicide or a fungicide.

12. The encapsulated agricultural chemical composition of claim 10 wherein the particles have a mean particle size from 5 microns to 25 microns.

13. The encapsulated agricultural chemical composition of claim 10 wherein when tested according to the Test Methods, the release of agricultural chemical from the composition after 15 days from 1 percent to 70 percent.

14. A process to make an encapsulated agricultural chemical composition of claim 10 comprising the steps of:
(a) Making an emulsion, which contains a dispersed organic phase comprising an agricultural chemical and polyisocyanate monomers, dispersed in a continuous aqueous phase; and
(b) Contacting the emulsion with polyamine monomers that include BPAA monomers, under conditions such that the polyisocyanate monomers and the polyamine monomers react to make a shell that contains polyurea polymer and encapsulates the agricultural chemical.
